(19) United States
(12) Patent Application Publication
(10) Pub. No.: US 2025/0330860 A1
(43) Pub. Date: Oct. 23, 2025

(54) AI/ML MODEL MONITORING METHOD AND APPARATUS

(71) Applicant: FUJITSU LIMITED, Kawasaki-shi (JP)

(72) Inventors: Yujia SHAN, Beijing (CN); Qun ZHANG, Beijing (CN)

(73) Assignee: FUJITSU LIMITED, Kawasaki-shi (JP)

(21) Appl. No.: 19/256,430

(22) Filed: Jul. 1, 2025

Related U.S. Application Data
(63) Continuation of application No. PCT/CN2023/071580, filed on Jan. 10, 2023.

(51) Int. Cl. H04W 24/10; H04B 17/318; H04L 41/16

(52) U.S. Cl. CPC H04W 24/10; H04B 17/328; H04L 41/16

(57) ABSTRACT

A model monitoring apparatus includes: a receiver configured to receive a model monitoring request transmitted by a model result output apparatus; and a transmitter configured to transmit request information for requesting model information to a model deployment apparatus, wherein the receiver is further configured to receive model information fed back by the model deployment apparatus.

### CROSS-REFERENCE TO RELATED APPLICATION

This application is a continuation application under 35 U.S.C. 111(a) of International Patent Application PCT/CN2023/071580 filed on Jan. 10, 2023, and designated the U.S., the entire contents of which are incorporated herein by reference.

### TECHNICAL FIELD

The present disclosure relates to the field of communication technologies.

### BACKGROUND

With commercialization of the fifth generation (5G) communication, especially large-scale expansion of the industrial Internet industry, the demand for positioning of terminal equipments in wireless communication has significantly increased. Traditional wireless positioning is based on multiple technologies, what is directly related to 5G NR (New Radio) mainly is positioning methods for performing estimation using a channel measurement result between a network entity and a terminal, such as TDOA (Time Difference Of Arrival), E-CID (Enhanced Cell ID) and Multi-RTT (Multi-Round-Trip Time). These traditional positioning methods all have several inherent defects, resulting in poorer positioning accuracy of a terminal equipment in different wireless environments or scenarios, in particular in a wireless environment with more severe non-line-of-sight (NLOS), such as an indoor factory (InF). In such environments, error values of traditional positioning methods are very large, which is generally difficult to be accepted. A root cause is that a positioning method based on wireless channel measurement is only effective in a line-of-sight (LOS) environment, a wireless channel measurement value obtained in a non-line-of-sight environment has a larger deviation from an ideal value, while the accuracy of a terminal positioning result directly depends on this measurement value. Therefore, the measurement error leads to occurrence of a final terminal positioning result error.

In recent years, artificial intelligence machine learning (AI/ML) technology, represented by deep learning, has developed rapidly, and has been applied to many research and commercial fields because of its powerful nonlinear fitting capability. Similarly, evaluation performance of artificial intelligence application in wireless positioning has also been greatly improved compared with traditional methods.

However, due to complexity and variability of wireless communication environments and inherent characteristics of a big data-based AI/ML model for wireless positioning, generalization ability (consistency of performing inference operations using the same model in different environments) performance of the AI/ML model when it is applied to wireless positioning is poorer. If the performance of a current AI/ML model has not met a positioning performance demand, it needs to timely perform model monitoring and make further operations on the AI/ML model through a monitoring result, such as model re-selection, model switching, model rollback, etc.

It should be noted that the above introduction to the technical background is just to facilitate a clear and complete description of the technical solutions of the present disclosure, and is elaborated to facilitate understanding of persons skilled in the art. It cannot be considered that these technical solutions are known by persons skilled in the art just because these solutions are elaborated in the Background Art of the present disclosure.

### SUMMARY

However, the inventor finds that when positioning is performed using a traditional method, no matter how the performance is, a corresponding mathematical model and a calculation module of the method itself are fixed, there is no corresponding supervision mechanism, thus real-time accuracy obtained when positioning is performed using a traditional method may not be accurately measured. Generally speaking, since an AI/ML model is data-driven and a training process is based on ground truth labels, so as long as the ground truth labels may be obtained via other methods, the performance of the model may be measured by comparing a difference between the ground truth labels and the output data of the AI/ML model according to certain metrics.

But the AI/ML model for positioning is rather special, LABEL data required for training may be obtained only through offline experimental equipment or simulation software, these data including a known position of a UE, a TOA (time of arrival of a signal) between the UE and a gNB, or LOS/NLOS information between channel links, etc. Therefore, these LABEL data are only applicable to a process of model construction, and once they are deployed in an operational communication network, these data may not be obtained online. As a result, related model detection methods are not applicable to wireless positioning.

To sum up, a model monitoring mechanism for wireless communication positioning is needed. Wireless positioning process defined in the current 3GPP protocol does not involve a concept related to the AI/ML model, hence a series of model monitoring processes are not clearly defined in the current protocol.

Addressed to at least one of the above problems, the embodiments of the present disclosure provide an AI/ML model monitoring method and apparatus, which enables data interaction and model monitoring between positioning-involved network entities and/or between a network entity and a terminal which are involved in positioning, so as to optimize a wireless positioning AI/ML model and obtain a more accurate positioning result.

According to one aspect of the embodiments of the present disclosure, an AI/ML model monitoring method is provided, including:
a model monitoring apparatus receives a model monitoring request transmitted by a model result output apparatus;
the model monitoring apparatus transmits request information for requesting model information to a model deployment apparatus; and
the model monitoring apparatus receives model information fed back by the model deployment apparatus.

According to another aspect of the embodiments of the present disclosure, a model monitoring apparatus is provided, including:
a first receiving unit configured to receive a model monitoring request transmitted by a model result output apparatus; and
a first transmitting unit configured to transmit request information for requesting model information to a model deployment apparatus, the first receiving unit further receiving model information fed back by the model deployment apparatus.

According to another aspect of the embodiments of the present disclosure, an AI/ML model monitoring method is provided, including:
a model result output apparatus transmits a model monitoring request to a model monitoring apparatus,
wherein the model monitoring apparatus transmits request information for requesting model information to a model deployment apparatus, and receives model information fed back by the model deployment apparatus.

According to another aspect of the embodiments of the present disclosure, a model result output apparatus is provided, including:
a second transmitting unit configured to transmit a model monitoring request to a model monitoring apparatus,
wherein the model monitoring apparatus transmits request information for requesting model information to a model deployment apparatus, and receives model information fed back by the model deployment apparatus.

According to another aspect of the embodiments of the present disclosure, an AI/ML model monitoring method is provided, including:
a model deployment apparatus receives request information for requesting model information from the model monitoring apparatus; and
the model deployment apparatus feeds back model information to the model monitoring apparatus.

According to another aspect of the embodiments of the present disclosure, a model deployment apparatus is provided, including:
a third receiving unit configured to receive request information for requesting model information from the model monitoring apparatus; and
a third transmitting unit configured to feed back model information to the model monitoring apparatus.

One of advantageous effects of the embodiments of the present disclosure lies in: a model monitoring apparatus receives a model monitoring request transmitted by a model result output apparatus, transmits request information for requesting model information to a model deployment apparatus, and receives model information fed back by the model deployment apparatus, thereby, real-time data collection and model monitoring are able to be performed between positioning-involved network entities and/or between a network entity and a terminal which are involved in positioning, so as to optimize a wireless positioning AI/ML model, and performance of the AI/ML model for wireless positioning is better and/or generalization thereof is better, whereby a more accurate positioning result is able to be obtained.

Referring to the later description and drawings, specific implementations of the present disclosure are disclosed in detail, indicating a mode that the principle of the present disclosure may be adopted. It should be understood that the implementations of the present disclosure are not limited in terms of a scope. Within the scope of the spirit and terms of the attached claims, the implementations of the present disclosure include many changes, modifications and equivalents.

Features that are described and/or illustrated with respect to one implementation may be used in the same way or in a similar way in one or more other implementations and in combination with or instead of the features in the other implementations.

It should be emphasized that the term “comprise/include” when being used herein refers to presence of a feature, a whole piece, a step or a component, but does not exclude presence or addition of one or more other features, whole pieces, steps or components.

### BRIEF DESCRIPTION OF DRAWINGS

An element and a feature described in a drawing or an implementation of the embodiments of the present disclosure may be combined with an element and a feature shown in one or more other drawings or implementations. In addition, in the drawings, similar labels represent corresponding components in several drawings and may be used to indicate corresponding components used in more than one implementation.

The included drawings are used to provide a further understanding on the embodiments of the present disclosure, constitute a part of the Specification, are used to illustrate the implementations of the present disclosure, and expound the principle of the present disclosure together with the text description. Obviously, the drawings in the following description are only some embodiments of the present disclosure. Persons skilled in the art may further obtain other drawings according to these drawings under the premise that they do not pay inventive labor. In the drawings:

FIG. 1 is a schematic diagram of an application scenario of the embodiments of the present disclosure;

FIG. 2 is a schematic diagram of an AI/ML model monitoring method in the embodiments of the present disclosure;

FIG. 3 is another schematic diagram of an AI/ML model monitoring method in the embodiments of the present disclosure;

FIG. 4 is another schematic diagram of an AI/ML model monitoring method in the embodiments of the present disclosure;

FIG. 5 is another schematic diagram of an AI/ML model monitoring method in the embodiments of the present disclosure;

FIG. 6 is another schematic diagram of an AI/ML model monitoring method in the embodiments of the present disclosure;

FIG. 7 is a schematic diagram of a model monitoring apparatus in the embodiments of the present disclosure;

FIG. 8 is a schematic diagram of a model result output apparatus in the embodiments of the present disclosure;

FIG. 9 is a schematic diagram of a model deployment apparatus in the embodiments of the present disclosure; and

FIG. 10 is a schematic diagram of an electronic device in the embodiments of the present disclosure.

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which may adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as Long Term Evolution (LTE), LTE-Advanced (LTE-A), Wideband Code Division Multiple Access (WCDMA), High-Speed Packet Access (HSPA) and so on.

And, communication between devices in a communication system may be carried out according to a communication protocol at any stage, for example may include but be not limited to the following communication protocols: 1G (generation), 2G, 2.5G, 2.75G, 3G, 4G, 4.5G, and future 5G, New Radio (NR) and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: a Base Station (BS), an Access Point (AP), a Transmission Reception Point (TRP) node, a broadcast transmitter, a Mobile Management Entity (MME), a gateway, a server, a Radio Network Controller (RNC), a Base Station Controller (BSC) and so on.

The base station may include but be not limited to: a node B (NodeB or NB), an evolution node B (eNodeB or eNB), a 5G base station (gNB) and an IAB donor, etc., and may further includes a Remote Radio Head (RRH), a Remote Radio Unit (RRU), a relay or a low power node (such as femto, pico, etc.). And the term “base station” may include their some or all functions, each base station may provide communication coverage to a specific geographic region. The term “cell” may refer to a BS and/or its coverage area, which depends on the context in which this term is used.

In the embodiments of the present disclosure, the term “a User Equipment (UE)” refers to, for example, a device that accesses a communication network and receives network services through a network device, or may also be called “Terminal Equipment (TE)”. The terminal equipment may be fixed or mobile, and may also be called a Mobile Station (MS), a terminal, a user, a Subscriber Station (SS), an Access Terminal (AT) and a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera and so on.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal and so on.

Scenarios of the embodiments of the present disclosure are described through the following examples, however the present disclosure is not limited to these.

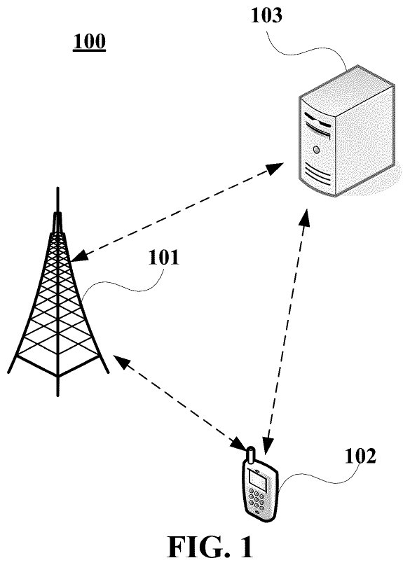

FIG. 1 is a schematic diagram of a communication system in the embodiments of the present disclosure, schematically describes situations by taking a terminal equipment and a network device as examples, as shown in FIG. 1, a communication system 100 may include a network device 101, a terminal equipment 102 and a positioning server 103. For simplicity, FIG. 1 only takes one terminal equipment and one network device as examples for description, however the embodiments of the present disclosure are not limited to this.

In the embodiments of the present disclosure, transmission of existing or further implementable services may be carried out between the network device 101 and the terminal equipment 102. For example, these services may include but be not limited to: enhanced Mobile Broadband (eMBB), massive Machine Type Communication (mMTC), Ultra-Reliable and Low-Latency Communication (URLLC) and so on.

It is worth noting that FIG. 1 shows that the terminal equipment 102 is within the coverage of network device 101, but the present disclosure is not limited to this. The terminal equipment 102 may not be within the coverage of network device 101. In addition, FIG. 1 takes “the positioning server 103 is deployed separately” as an example for description, an AI model may be run in the positioning server 103 to obtain a positioning result; however the present disclosure is not limited to this, the positioning server 103 may be deployed in a core network, may be deployed in the network device 102 (such as a base station), or may be deployed in the terminal equipment 103; the embodiments of the present disclosure do not limit these situations.

In the embodiments of the present disclosure, the terminal equipment to be positioned may be called a target device, and the function of the positioning server is called a Location Management Function (LMF). The LMF may be a network entity that positions and manages terminals, or a location server that has the location management function may be called LMF for short. In a case where there is no confusion, the terms “LMF” and “location server” are replaced mutually. For specific contents of these concepts and positioning, relevant technologies may be referred to.

Based on current research, a monitoring (or also called supervision) mode for a wireless communication positioning AI/ML model includes: monitoring based on model OUTPUT and monitoring based on model INPUT, after the start of a model life cycle (marked as model activation), a model monitoring entity needs to select a monitoring mode in real time according to model information and environmental information. The embodiments of the present disclosure pay attention to interaction of such information. In addition, if INPUT is selected as a model monitoring mode, for metrics calculation and confidence information of INPUT, there is also information that needs to be interacted between entities.

In the embodiments of the present disclosure, the model deployment apparatus (also called a model deployment module or model deployment entity) may be a UE, gNB or LMF, or may be part of a function or entity of any of the above devices. The model monitoring apparatus (also called a model monitoring module or model monitoring entity) may be a UE, gNB, Positioning Reference Unit (PRU) or LMF, or may be part of a function or entity of any of the above devices. The model result output apparatus (also called a model result output module or model result output entity) may be a UE, gNB or LMF, or may be part of a function or entity of any of the above devices.

In addition, the above apparatuses may be combined. For example, the UE may simultaneously include the model deployment apparatus and the model result output apparatus, the model monitoring apparatus is provided in a gNB or LMF. For another example, the gNB may simultaneously include the model deployment apparatus and the model monitoring apparatus, and the model result output apparatus is provided in the LMF. The present disclosure is not limited to this.

### Embodiments of a First Aspect

Embodiments of the present disclosure provide an AI/ML model monitoring method, which is described from a model monitoring apparatus side. The model monitoring apparatus may be a network device (such as a base station), or may be a terminal equipment (such as a target device, a PRU or other terminal), or may further be a location server having an LMF function.

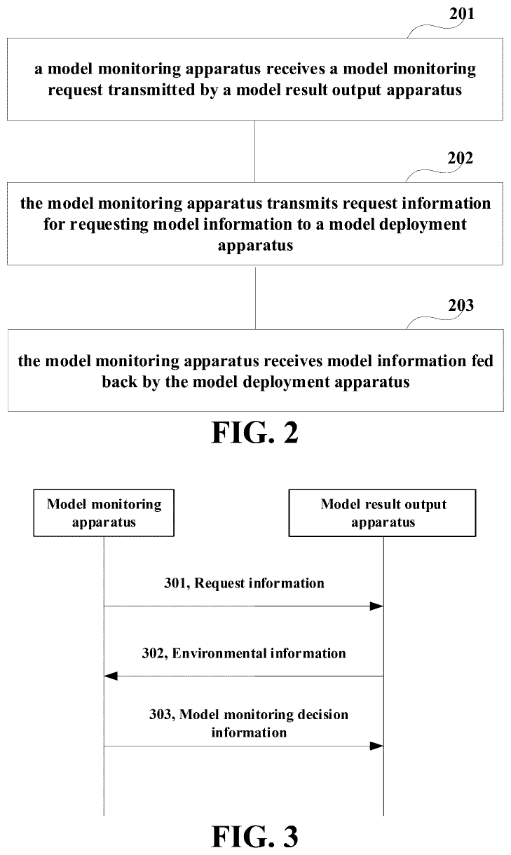

FIG. 2 is a schematic diagram of an AI/ML model monitoring method in the embodiments of the present disclosure. As shown in FIG. 2, the method includes:
201, a model monitoring apparatus receives a model monitoring request transmitted by a model result output apparatus;
202, the model monitoring apparatus transmits request information for requesting model information to a model deployment apparatus; and
203, the model monitoring apparatus receives model information fed back by the model deployment apparatus.

It should be noted that the above FIG. 2 only schematically describes the embodiments of the present disclosure, but the present disclosure is not limited to this. For example, an execution step of each operation may be adjusted appropriately, moreover other some operations may be increased or reduced. Persons skilled in the art may make appropriate modifications according to the above contents, not limited to the records in the above FIG. 2.

Thereby, a model monitoring apparatus receives a model monitoring request transmitted by a model result output apparatus, transmits request information for requesting model information to a model deployment apparatus, and receives model information fed back by the model deployment apparatus. Thereby, real-time data collection and model monitoring are able to be performed between positioning-involved network entities and/or between a network entity and a terminal which are involved in positioning, so as to optimize a wireless positioning AI/ML model, performance of the AI/ML model for wireless positioning is better and/or generalization thereof is better, whereby a more accurate positioning result is able to be obtained.

In some embodiments, the model deployment apparatus may report model information to a model monitoring apparatus actively or upon request.

In some embodiments, the model monitoring apparatus specifies a reporting period and a maximum reporting resource in the request information, and the model deployment apparatus determines the fed-back model information within a range of the maximum reporting resource according to the reporting period.

For example, the model deployment apparatus may report semi-actively, and a reporting content is determined by a model deployment module autonomously. Due to complexity of model information, it is impossible to all update by means of model identification. In case of taking into account resource transmission, a reporting period and a maximum reporting resource allowed by an entity may be specified by the model monitoring apparatus, the model deployment apparatus semi-autonomously determines a reporting content using a specified resource at a specified time and may select one or more reporting contents from an IE.

In some embodiments, the model monitoring apparatus specifies a reporting mode and reporting contents in the request information, and the model deployment apparatus feeds back the model information according to the reporting mode and the reporting contents.

For example, the model deployment apparatus may report passively, that is, the model monitoring apparatus specifies a reporting mode and a reporting content, and the model deployment apparatus is not able to choose by itself to feed back model information according to the specified reporting mode and reporting content.

In some embodiments, the model monitoring apparatus transmits the request information periodically, or the model monitoring apparatus transmits the request information aperiodically.

For example, the model monitoring apparatus specifies a reporting period, and the model deployment apparatus periodically reports in a specified time. For another example, the model deployment apparatus reports irregularly, and transmits model information as required after receiving FEEDBACK (the request information above) from the model monitoring apparatus, without specifying a period.

In some embodiments, the model information includes at least one of the following: data statistical information, latency distribution information, or reception beam information. The present disclosure is not limited to this, the above information may be combined arbitrarily, or may further include other information.

In some embodiments, the data statistical information includes at least one of the following: statistical average data of a channel impulse response (CIR), peak data of a CIR, statistical average data of reference signal received power (RSRP), peak data of RSRP, statistical average data of RSRPP, peak data of RSRPP, a cell identification to which a device providing input data corresponds, or distribution information of reception beams corresponding to input data.

The above text exemplarily shows the data statistical information. The present disclosure is not limited to this, it may further include other information. In addition, the above information may be absolute numerical information or may further be relative numerical information. For example, a variation in a CIR mean relative to the Mth period statistic may be used.

FIG. 3 is another schematic diagram of an AI/ML model monitoring method in the embodiments of the present disclosure. FIG. 3 may be executed alone or in combination with FIG. 2. As shown in FIG. 3, the method includes:
301, the model monitoring apparatus transmits request information for requesting environmental information to the model result output apparatus; and
302, the model monitoring apparatus receives environmental information fed back by the model result output apparatus.

In some embodiments, the environmental information includes at least one of the following: signal measurement information, or environmental statistical information; the environmental statistical information includes at least one of the following: positioning reference unit (PRU) information, positioning reference unit (PRU) statistical information, non-radio access technology (NON-RAT) information, non-radio access technology (NON-RAT) positioning statistical information, or LOS/NLOS statistical information. The present disclosure is not limited to this, the above information may be combined arbitrarily, or may further include other information.

Table 1 is an example exemplarily showing PRU information.

TABLE 1

| PRUInfo:: = Sequence { | |
|---|---|
| PRU_ID | ... |
| PRU_Pos | ... |
| PRU_BEAMInfo | ... |

...
}

As shown in Table 1, for example, the PRU information may include a PRU ID, PRU positioning information, and PRU beam information, etc. The present disclosure is not limited to this, for example, it may further include other specific contents.

For another example, the positioning reference unit (PRU) statistical information includes at least one of the following: information on the number of available PRUs in the current environment, type information of available PRUs in the current environment, measurement content information supported by available PRUs in the current environment, beam information corresponding to available PRUs in the current environment, or measurement sample information able to be provided by available PRUs in the current environment.

Table 2 is an example exemplarily showing NON-RAT information.

TABLE 2

```
NonRATInfo ::= Sequence {
  NonRATMethod ENUMERATED {gnss, lidar, wifi, ...}
  NonRATMethodLatency ENUMERATED{0, 0.01, 0.1, ...}
  ...
}
```

As shown in Table 1, for example, the NON-RAT information may include NON-RAT method information, NON-RAT method delay information, etc. The present disclosure is not limited to this, for example, it may further include other specific contents.

For another example, the NON-RAT positioning statistical information includes at least one of the following: positioning manner information of an available NON-RAT in the current environment, positioning accuracy information of the available NON-RAT in the current environment, or content information required for implementing the NON-RAT.

For example, the LOS/NLOS statistical information includes at least one of the following: LOS/NLOS ratio information per cell, or LOS/NLOS ratio information per transmit beam (tx beam).

As shown in FIG. 3, the method may further include:
303, the model monitoring apparatus feeds back model monitoring decision information to the model result output apparatus.

In some embodiments, the model monitoring decision information includes at least one of the following: monitoring type information, metric calculation information corresponding to monitoring modes, input monitoring information, or output monitoring information. The input monitoring information including at least one of the following: an input type, confidence information of model input monitoring, accuracy information of model input monitoring, or metric information of model input monitoring. The present disclosure is not limited to this, the above information may be combined arbitrarily, or may further include other information.

Table 3 is an example exemplarily showing monitoring type information.

TABLE 3

```
MonitoringTypeAIML:: = ENUMERATED {
  InputMonitoring
  OutputMonitoring
  Others
  ...
}
```

As shown in Table 3, for example, the monitoring type information may include input monitoring, output monitoring and others. The present disclosure is not limited to this, for example, it may further include other specific contents.

For example, in a case where the monitoring type information is of an input type, the metric calculation information includes at least one of the following: statistical information of real-time reporting model input, collection period information, quality threshold information, a monitoring period, or monitoring metrics.

Table 4 is an example exemplarily showing metric calculation information.

TABLE 4
InputMonitoringMetricInfo:: = Sequence {

| | |
|---|---|
| MonitoringPeriod | ENUMERATED {0, 1, 2, ..., 10} |
| MonitoringMetric | ENUMERATED {MSE, NMSE, MAE, ...} |

```
  Others
  ...
}
```

As shown in Table 4, for example, input monitoring metric information may include a monitoring period, monitoring metric, and others. The present disclosure is not limited to this, for example, it may further include other specific contents.

For another example, in a case where the monitoring type information is of an output type, the metric calculation information includes at least one of the following: information required for calculation of positioning reference units (PRUs), information required for calculation of a NON-RAT positioning mode, PRU information, or NON-RAT information.

Table 5 is an example exemplarily showing metric calculation information.

TABLE 5

| OutputMonitoringMetricInfo:: = Sequence { | |
|---|---|
| PRUInfo | PRUInfo |
| NonRATInfo | NonRATInfo |

```
  Others
  ...
}
```

As shown in Table 5, for example, output monitoring metric information may include PRU information, NON-RAT information and others. The present disclosure is not limited to this, for example, it may further include other specific contents.

Table 6 is an example exemplarily showing input monitoring information.

```
TABLE 6
InputMonitoringInfo:: = SEQUENCE {
  InputType ENUMERATED{L1_RSRP, RSRPP, CIR, CFR, TOA,
TDOA, Others},
  MonitoringConfidence ENUMERATED {0, 0.1, 0.2, ..., 0.9. 1},
  MonitoringAccuracy ENUMERATED {0, 1, 2, 3, ..., 9, 10},
  MonitoringMetricInfo InputMonitoringMetricInfo
  ...
}
```

As shown in Table 6, for example, input monitoring information may include an input type, monitoring confidence, monitoring accuracy, and monitoring metric information. The present disclosure is not limited to this, for example, it may further include other specific contents.

For example, the input type (InputType) may be one of L1_RSRP, reference signal received path power (RSRPP), CIR, channel frequency response (CFR), TOA and TDOA. The monitoring confidence (MonitoringConfidence) represents confidence of a corresponding monitoring method. For example, a value of the confidence ranges from 0 to 1, a value interval is 0.1, corresponding to 0% to 100% confidence probability. A specific statistical method may be specifically implemented according to an actual situation. For another example, the monitoring accuracy (MonitoringAccuracy) represents accuracy of a corresponding monitoring method, a value ranges from 0 to 10, a value interval is 1, with the unit being meter.

It should be noted that the above FIG. 3 only schematically describes the embodiments of the present disclosure, but the present disclosure is not limited to this. For example, an execution step of each operation may be adjusted appropriately, moreover other some operations may be increased or reduced. Persons skilled in the art may make appropriate modifications according to the above contents, not limited to the records in the above FIG. 3.

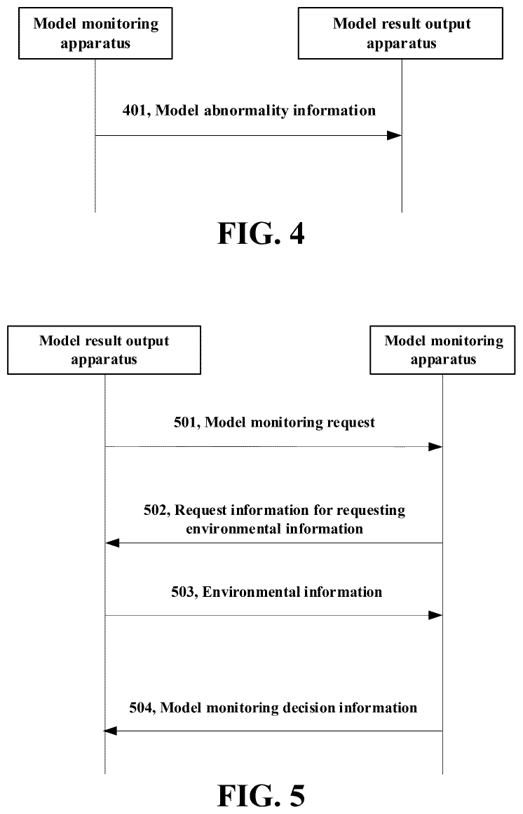

FIG. 4 is another schematic diagram of an AI/ML model monitoring method in the embodiments of the present disclosure. FIG. 4 may be executed alone or in combination with FIG. 2 or FIG. 3. As shown in FIG. 4, the method includes:
401, the model monitoring apparatus further transmits model abnormality information to the model result output apparatus in a case where no statistical information is able to be obtained.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the embodiments of the present disclosure, real-time data collection and model monitoring are able to be performed between positioning-involved network entities and/or between a network entity and a terminal which are involved in positioning, so as to optimize a wireless positioning AI/ML model, performance of the AI/ML model for wireless positioning is better and/or generalization thereof is better, whereby a more accurate positioning result is able to be obtained.

### Embodiments of a Second Aspect

Embodiments of the present disclosure provide an AI/ML model monitoring method, which is described from a model result output apparatus side. Embodiments of the second aspect correspond to the embodiments of the first aspect, the same contents are not repeated.

FIG. 5 is another schematic diagram of an AI/ML model monitoring method in the embodiments of the present disclosure. As shown in FIG. 5, the method includes:
501, a model result output apparatus transmits a model monitoring request to a model monitoring apparatus,
wherein the model monitoring apparatus transmits request information for requesting model information to a model deployment apparatus, and receives model information fed back by the model deployment apparatus.

For example, the model deployment apparatus and the model result output apparatus may be set in a UE, and the model monitoring apparatus may be set in a gNB or LMF. That is, the AI/ML model is of a direct type, the UE outputs a model result locally, and model supervision is located in the gNB or LMF. The UE may perform model identification to a network side and initiate a model life cycle to activate an AI/ML model for positioning. The UE initiates a model monitoring request to the gNB/LMF, additional information may be added.

In some embodiments, as shown in FIG. 5, the method may further include:
502, the model result output apparatus receives request information for requesting environmental information from the model monitoring apparatus; and
503, the model result output apparatus feeds back the environmental information to the model monitoring apparatus.

In some embodiments, the environmental information includes at least one of the following: signal measurement information, or environmental statistical information;
The environmental statistical information includes at least one of the following: positioning reference unit (PRU) information, positioning reference unit (PRU) statistical information, NON-RAT information, NON-RAT positioning statistical information, or LOS/NLOS statistical information.

In some embodiments, the positioning reference unit (PRU) statistical information includes at least one of the following: information on the number of available PRUs in the current environment, type information of available PRUs in the current environment, measurement content information supported by available PRUs in the current environment, beam information corresponding to available PRUs in the current environment, or measurement sample information able to be provided by available PRUs in the current environment;
the NON-RAT positioning statistical information includes at least one of the following: positioning manner information of an available NON-RAT in the current environment, positioning accuracy information of the available NON-RAT in the current environment, or content information required for implementing the NON-RAT;
the LOS/NLOS statistical information includes at least one of the following: LOS/NLOS ratio information per cell, or LOS/NLOS information per transmit beam.

For example, the model deployment apparatus and the model monitoring apparatus may be set in a gNB, and the model result output apparatus may be set in an LMF. That is, the AI/ML model is of an indirect type, the LMF outputs a model result. The gNB may initiate model monitoring and transmits environmental information request signaling to the LMF. The LMF transmits the environmental statistical information to the gNB, including PRU statistical information, NON-RAT positioning mode information, or LOS/NLOS statistical information, etc.

In some embodiments, as shown in FIG. 5, the method may further include:
504, the model result output apparatus receives model monitoring decision information fed back by the model monitoring apparatus.

In some embodiments, the model monitoring decision information includes at least one of the following: monitoring type information, metric calculation information corresponding to monitoring modes, input monitoring information, or output monitoring information.

In some embodiments, the input monitoring information including at least one of the following: an input type, confidence information of model input monitoring, accuracy information of model input monitoring, or metric information of model input monitoring.

In some embodiments, in a case where the monitoring type information is of an input type, the metric calculation information includes at least one of the following: statistical information of real-time reporting model input, collection period information, quality threshold information, a monitoring period, or monitoring metrics; in a case where the monitoring type information is of an output type, the metric calculation information includes at least one of the following: information required for calculation of positioning reference units (PRUs), information required for calculation of a NON-RAT positioning mode, positioning reference unit (PRU) information, or NON-RAT information.

For example, the model deployment apparatus and the model monitoring apparatus may be set in a gNB, and the model result output apparatus may be set in an LMF. That is, the AI/ML model is of an indirect type, the LMF outputs a model result. The gNB may transmit monitoring mode information to the LMF according to the collected comprehensive information, which may include: a supervision type: an input type, an output type, or others. Metrics corresponding to the supervision type calculates required additional information, for example in case of an input type, statistical information of real-time reporting model input, a collection period, a quality threshold, etc.; in case of an output type, additional information required for calculation of reporting PRUs or NON-RAT.

For another example, the model deployment apparatus and the model monitoring apparatus may be set in a gNB, and the model result output apparatus may be set in an LMF. That is, the AI/ML model is of an indirect type, the LMF outputs a model result. The gNB may transmit monitoring mode information to the LMF according to the collected comprehensive information, which may include: confidence information and/or accuracy information, etc.

In some embodiments, the model result output apparatus receives model abnormality information transmitted by the model monitoring apparatus in a case where no statistical information is able to be obtained.

It should be noted that the above FIG. 5 only schematically describes the embodiments of the present disclosure, but the present disclosure is not limited to this. For example, an execution step of each operation may be adjusted appropriately, moreover other some operations may be increased or reduced. Persons skilled in the art may make appropriate modifications according to the above contents, not limited to the records in the above FIG. 5.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the embodiments of the present disclosure, real-time data collection and model monitoring are able to be performed between positioning-involved network entities and/or between a network entity and a terminal which are involved in positioning, so as to optimize a wireless positioning AI/ML model, performance of the AI/ML model for wireless positioning is better and/or generalization thereof is better, whereby a more accurate positioning result is able to be obtained.

### Embodiments of a Third Aspect

Embodiments of the present disclosure provide an AI/ML model monitoring method, which is described from a model deployment apparatus side. Embodiments of the third aspect correspond to the embodiments of the first aspect, the same contents are not repeated.

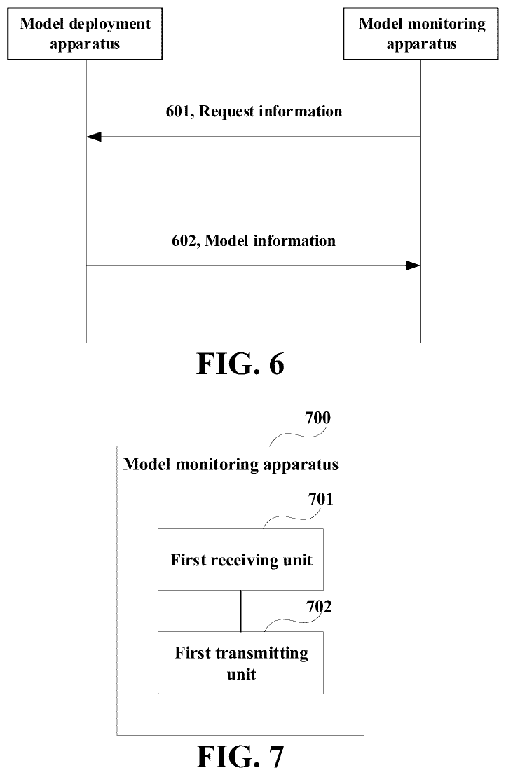

FIG. 6 is another schematic diagram of an AI/ML model monitoring method in the embodiments of the present disclosure. As shown in FIG. 6, the method includes:
601, a model deployment apparatus receives request information for requesting model information from the model monitoring apparatus; and
602, the model deployment apparatus feeds back model information to the model monitoring apparatus.

In some embodiments, the model monitoring apparatus specifies a reporting period and a maximum reporting resource in the request information, and the model deployment apparatus determines the fed-back model information within a range of the maximum reporting resource according to the reporting period.

In some embodiments, the model monitoring apparatus specifies a reporting mode and reporting contents in the request information, and the model deployment apparatus feeds back the model information according to the reporting mode and the reporting contents.

In some embodiments, the model monitoring apparatus transmits the request information periodically, or the model monitoring apparatus transmits the request information aperiodically.

In some embodiments, the model information includes at least one of the following: data statistical information, latency distribution information, or reception beam information. The data statistical information includes at least one of the following: statistical average data of a CIR, peak data of a CIR, statistical average data of RSRP, peak data of RSRP, statistical average data of RSRPP, peak data of RSRPP, a cell identification to which a device providing input data corresponds, or distribution information of reception beams corresponding to input data.

For example, the model deployment apparatus and the model result output apparatus may be set in a UE, and the model monitoring apparatus may be set in a gNB or LMF. That is, the AI/ML model is of a direct type, the UE outputs a model result locally, and model supervision is located in the gNB or LMF. The gNB/LMF may transmit request information for requesting model information to the UE, and additional information may be specified. The UE may transmit model information, including: model training data statistical information, such as RSRP, RSRPP, etc.; current received BEAM information of the UE, etc.

It should be noted that the above FIG. 6 only schematically describes the embodiments of the present disclosure, but the present disclosure is not limited to this. For example, an execution step of each operation may be adjusted appropriately, moreover other some operations may be increased or reduced. Persons skilled in the art may make appropriate modifications according to the above contents, not limited to the records in the above FIG. 6.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the embodiments of the present disclosure, real-time data collection and model monitoring are able to be performed between positioning-involved network entities and/or between a network entity and a terminal which are involved in positioning, so as to optimize a wireless positioning AI/ML model, performance of the AI/ML model for wireless positioning is better and/or generalization thereof is better, whereby a more accurate positioning result is able to be obtained.

### Embodiments of a Fourth Aspect

Embodiments of the present disclosure provide a model monitoring apparatus. The principle of the model monitoring apparatus to solve a problem is the same as the method in the embodiments of the first aspect, thus its specific implementation may refer to the embodiments of the first aspect, the same contents are not repeated.

FIG. 7 is a schematic diagram of a model monitoring apparatus in the embodiments of the present disclosure. As shown in FIG. 7, a model monitoring apparatus 700 in the embodiments of the present disclosure includes:
a first receiving unit 701 configured to receive a model monitoring request transmitted by a model result output apparatus; and
a first transmitting unit 702 configured to transmit request information for requesting model information to a model deployment apparatus,
the first receiving unit 701 further receiving model information fed back by the model deployment apparatus.

In some embodiments, the first transmitting unit 702 specifies a reporting period and a maximum reporting resource in the request information, and the model deployment apparatus determines the fed-back model information within a range of the maximum reporting resource according to the reporting period.

In some embodiments, the first transmitting unit 702 specifies a reporting mode and reporting contents in the request information, and the model deployment apparatus feeds back the model information according to the reporting mode and the reporting contents.

In some embodiments, the first transmitting unit 702 periodically transmits the request information, or the first transmitting unit 702 aperiodically transmits the request information.

In some embodiments, the model information includes at least one of the following: data statistical information, latency distribution information, or reception beam information.

In some embodiments, the data statistical information includes at least one of the following: statistical average data of a CIR, peak data of a CIR, statistical average data of RSRP, peak data of RSRP, statistical average data of RSRPP, peak data of RSRPP, a cell identification to which a device providing input data corresponds, or distribution information of reception beams corresponding to input data.

In some embodiments, the first transmitting unit 702 further transmits request information for requesting environmental information to the model result output apparatus; and the first receiving unit 701 further receives environmental information fed back by the model result output apparatus.

In some embodiments, the environmental information includes at least one of the following: signal measurement information, or environmental statistical information.

In some embodiments, the environmental statistical information includes at least one of the following: positioning reference unit (PRU) information, positioning reference unit (PRU) statistical information, NON-RAT information, NON-RAT positioning statistical information, or LOS/NLOS statistical information.

In some embodiments, the positioning reference unit (PRU) statistical information includes at least one of the following: information on the number of available PRUs in the current environment, type information of available PRUs in the current environment, measurement content information supported by available PRUs in the current environment, beam information corresponding to available PRUs in the current environment, or measurement sample information able to be provided by available PRUs in the current environment;
the NON-RAT positioning statistical information includes at least one of the following: positioning manner information of an available NON-RAT in the current environment, positioning accuracy information of the available NON-RAT in the current environment, or content information required for implementing the NON-RAT;
the LOS/NLOS statistical information includes at least one of the following: LOS/NLOS ratio information per cell, or LOS/NLOS information per transmit beam.

In some embodiments, the first transmitting unit 702 further feeds back model monitoring decision information to the model result output apparatus.

In some embodiments, the model monitoring decision information includes at least one of the following: monitoring type information, metric calculation information corresponding to monitoring modes, input monitoring information, or output monitoring information.

In some embodiments, the input monitoring information including at least one of the following: an input type, confidence information of model input monitoring, accuracy information of model input monitoring, or metric information of model input monitoring.

In some embodiments, in a case where the monitoring type information is of an input type, the metric calculation information includes at least one of the following: statistical information of real-time reporting model input, collection period information, quality threshold information, a monitoring period, or monitoring metrics.

In some embodiments, in a case where the monitoring type information is of an output type, the metric calculation information includes at least one of the following: information required for calculation of positioning reference units (PRUs), information required for calculation of a NON-RAT positioning mode, positioning reference unit (PRU) information, or NON-RAT information.

In some embodiments, the first transmitting unit 702 further transmits model abnormality information to the model result output apparatus in a case where no statistical information is able to be obtained.

Moreover, for the sake of simplicity, FIG. 7 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the embodiments of the present disclosure, real-time data collection and model monitoring are able to be performed between positioning-involved network entities and/or between a network entity and a terminal which are involved in positioning, so as to optimize a wireless positioning AI/ML model, performance of the AI/ML model for wireless positioning is better and/or thereof generalization is better, whereby a more accurate positioning result is able to be obtained.

### Embodiments of a Fifth Aspect

Embodiments of the present disclosure provide a model result output apparatus. The principle of the model result output apparatus to solve a problem is the same as the method in the embodiments of the second aspect, thus its specific implementation may refer to the embodiments of the first and second aspects, the same contents are not repeated.

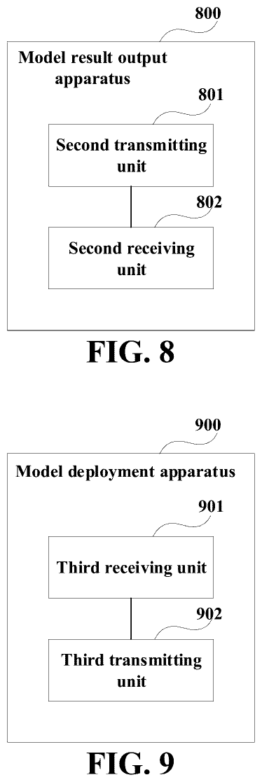

FIG. 8 is a schematic diagram of a model result output apparatus in the embodiments of the present disclosure. As shown in FIG. 8, a model result output apparatus 800 in the embodiments of the present disclosure includes:
a second transmitting unit 801 configured to transmit a model monitoring request to a model monitoring apparatus,
wherein the model monitoring apparatus transmits request information for requesting model information to a model deployment apparatus, and receives model information fed back by the model deployment apparatus.

In some embodiments, as shown in FIG. 8, the model result output apparatus 800 may further include:
a second receiving unit 802 configured to receive request information for requesting environmental information from the model monitoring apparatus,
and the second transmitting unit 801 further feeds back the environmental information to the model monitoring apparatus.

In some embodiments, the second receiving unit 802 further receives model monitoring decision information fed back by the model monitoring apparatus.

In some embodiments, the second receiving unit 802 further receives model abnormality information transmitted by the model monitoring apparatus in a case where no statistical information is able to be obtained.

Moreover, for the sake of simplicity, FIG. 8 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the embodiments of the present disclosure, real-time data collection and model monitoring are able to be performed between positioning-involved network entities and/or between a network entity and a terminal which are involved in positioning, so as to optimize a wireless positioning AI/ML model, performance of the AI/ML model for wireless positioning is better and/or thereof generalization is better, whereby a more accurate positioning result is able to be obtained.

### Embodiments of a Sixth Aspect

Embodiments of the present disclosure provide a model deployment apparatus. The principle of the model deployment apparatus to solve a problem is the same as the method in the embodiments of the third aspect, thus its specific implementation may refer to the embodiments of the first to third aspects, the same contents are not repeated.

FIG. 9 is a schematic diagram of a model deployment apparatus in the embodiments of the present disclosure. As shown in FIG. 9, a model deployment apparatus 900 in the embodiments of the present disclosure includes:
a third receiving unit 901 configured to receive request information for requesting model information from the model monitoring apparatus; and
a third transmitting unit 902 configured to feed back model information to the model monitoring apparatus.

Moreover, for the sake of simplicity, FIG. 9 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the embodiments of the present disclosure, real-time data collection and model monitoring are able to be performed between positioning-involved network entities and/or between a network entity and a terminal which are involved in positioning, so as to optimize a wireless positioning AI/ML model, performance of the AI/ML model for wireless positioning is better and/or thereof generalization is better, whereby a more accurate positioning result is able to be obtained.

### Embodiments of a Seventh Aspect

Embodiments of the present disclosure provide a communication system. FIG. 1 is a schematic diagram of a communication system in the embodiments of the present disclosure. As shown in FIG. 1, the communication system 100 includes a network device 101, a terminal equipment 102 and a positioning server 103. For simplicity, FIG. 1 only takes one network device and one terminal equipment as examples for description, however the embodiments of the present disclosure are not limited to this.

In some embodiments, the communication system includes a model monitoring apparatus 700; a model result output apparatus 800; and a model deployment apparatus 900.

Embodiments of the present disclosure further provide an electronic device, the electronic device e.g. is the model monitoring apparatus, or the model result output apparatus, or the model deployment apparatus as described above.

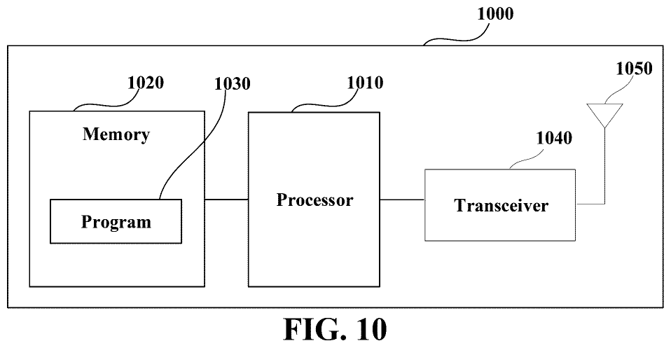

FIG. 10 is a schematic diagram of composition of an electronic device in the embodiments of the present disclosure. As shown in FIG. 10, the electronic device 1000 may include: a processor 1010 (such as a central processing unit (CPU)) and a memory 1020; the memory 1020 is coupled to the processor 1010. The memory 1020 may store various data; moreover, further stores a program 1030 for information processing, and executes the program 1030 under the control of the processor 1010.

For example, the processor 1010 may be configured to execute a program to implement the AI/ML model monitoring method as described in the embodiments of the first aspect. For example, the processor 1010 may be configured to perform the following control: receiving a model monitoring request transmitted by a model result output apparatus, transmitting request information for requesting model information to a model deployment apparatus, and receiving model information fed back by the model deployment apparatus.

For another example, the processor 1010 may be configured to execute a program to implement the AI/ML model monitoring method as described in the embodiments of the second aspect. For example, the processor 1010 may be configured to perform the following control: transmitting a model monitoring request to the model monitoring apparatus; wherein the model monitoring apparatus transmits request information for requesting model information to a model deployment apparatus, and receives model information fed back by the model deployment apparatus.

For another example, the processor 1010 may be configured to execute a program to implement the AI/ML model monitoring method as described in the embodiments of the third aspect. For example, the processor 1010 may be configured to perform the following control: receiving request information for requesting model information from the model monitoring apparatus; feeding back model information to the model monitoring apparatus.

In addition, as shown in FIG. 10, the electronic device 1000 may further include: a transceiver 1040 and an antenna 1050, etc., wherein the functions of said components are similar to relevant arts, which are not repeated here. It's worth noting that the electronic device 1000 does not have to include all the components shown in FIG. 10. Moreover, the electronic device 1000 may also include components not shown in FIG. 10, related arts may be referred to.

The embodiments of the present disclosure further provide a computer readable program, wherein when the program is executed in the model monitoring apparatus, the program enables a computer to execute the AI/ML model monitoring method as described in the embodiments of the first aspect, in the model monitoring apparatus.

The embodiments of the present disclosure further provide a storage medium in which a computer readable program is stored, wherein the computer readable program enables a computer to execute the AI/ML model monitoring method as described in the embodiments of the first aspect, in the model monitoring apparatus.

The embodiments of the present disclosure further provide a computer readable program, wherein when the program is executed in the model result output apparatus, the program enables a computer to execute the AI/ML model monitoring method as described in the embodiments of the second aspect, in the model result output apparatus.

The embodiments of the present disclosure further provide a storage medium in which a computer readable program is stored, wherein the computer readable program enables a computer to execute the AI/ML model monitoring method as described in the embodiments of the second aspect, in the model result output apparatus.

The embodiments of the present disclosure further provide a computer readable program, wherein when the program is executed in the model deployment apparatus, the program enables a computer to execute the AI/ML model monitoring method as described in the embodiments of the third aspect, in the model deployment apparatus.

The embodiments of the present disclosure further provide a storage medium in which a computer readable program is stored, wherein the computer readable program enables a computer to execute the AI/ML model monitoring method as described in the embodiments of the third aspect, in the model deployment apparatus.

The apparatus and method in the present disclosure may be realized by hardware, or may be realized by combining hardware with software. The present disclosure relates to such a computer readable program, when the program is executed by a logic component, the computer readable program enables the logic component to realize the device described in the above text or a constituent component, or enables the logic component to realize various methods or steps described in the above text. The logic component is e.g. a field programmable logic component, a microprocessor, a processor used in a computer, etc. The present disclosure further relates to a storage medium storing the program, such as a hard disk, a magnetic disk, an optical disk, a DVD, a flash memory and the like.

By combining with the method/device described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art may make various variations and modifications to the present disclosure according to the spirit and principle of the present disclosure, these variations and modifications are also within the scope of the present disclosure.

Regarding the above implementations disclosed in this embodiment, the following supplements are further disclosed:
1. An AI/ML model monitoring method, including:
a model monitoring apparatus receives a model monitoring request transmitted by a model result output apparatus;
the model monitoring apparatus transmits request information for requesting model information to a model deployment apparatus; and
the model monitoring apparatus receives model information fed back by the model deployment apparatus.
2. The method according to Supplement 1, wherein the model monitoring apparatus specifies a reporting period and a maximum reporting resource in the request information, and the model deployment apparatus determines the fed-back model information within a range of the maximum reporting resource according to the reporting period.
3. The method according to Supplement 1, wherein the model monitoring apparatus specifies a reporting mode and reporting contents in the request information, and the model deployment apparatus feeds back the model information according to the reporting mode and the reporting contents.
4. The method according to Supplement 1, wherein the model monitoring apparatus transmits the request information periodically, or the model monitoring apparatus transmits the request information aperiodically.
5. The method according to any one of Supplements 1 to 4, wherein the model information includes at least one of the following: data statistical information, latency distribution information, or reception beam information.
6. The method according to Supplement 5, wherein the data statistical information includes at least one of the following: statistical average data of a CIR, peak data of a CIR, statistical average data of RSRP, peak data of RSRP, statistical average data of RSRPP, peak data of RSRPP, a cell identification to which a device providing input data corresponds, or distribution information of reception beams corresponding to input data.
7. The method according to any one of Supplements 1 to 6, wherein the method further includes:
the model monitoring apparatus transmits request information for requesting environmental information to the model result output apparatus; and
the model monitoring apparatus receives environmental information fed back by the model result output apparatus.
8. The method according to Supplement 7, wherein the environmental information includes at least one of the following: signal measurement information, or environmental statistical information.
9. The method according to Supplement 8, wherein the environmental statistical information includes at least one of the following: positioning reference unit (PRU) information, positioning reference unit (PRU) statistical information, NON-RAT information, NON-RAT positioning statistical information, or LOS/NLOS statistical information.
10. The method according to Supplement 9, wherein
the positioning reference unit (PRU) statistical information includes at least one of the following: information on the number of available PRUs in a current environment, type information of available PRUs in the current environment, measurement content information supported by available PRUs in the current environment, beam information corresponding to available PRUs in the current environment, or measurement sample information able to be provided by available PRUs in the current environment.
11. The method according to Supplement 9, wherein
the NON-RAT positioning statistical information includes at least one of the following: positioning manner information of an available NON-RAT in the current environment, positioning accuracy information of the available NON-RAT in the current environment, or content information required for implementing the NON-RAT.
12. The method according to Supplement 9, wherein
the LOS/NLOS statistical information includes at least one of the following: LOS/NLOS ratio information per cell, or LOS/NLOS information per transmit beam.
13. The method according to any one of Supplements 1 to 12, wherein the method further includes:
the model monitoring apparatus feeds back model monitoring decision information to the model result output apparatus.
14. The method according to Supplement 13, wherein the model monitoring decision information includes at least one of the following: monitoring type information, metric calculation information corresponding to monitoring modes, model input information, or model output information;
the model input information including at least one of the following: confidence information of model input monitoring, accuracy information of model input monitoring, or metric information of model input monitoring.
15. The method according to Supplement 14, wherein in a case where the monitoring type information is of an input type, the metric calculation information includes at least one of the following: statistical information of real-time reporting model input, collection period information, quality threshold information, a monitoring period, or monitoring metrics.
16. The method according to Supplement 14, wherein in a case where the monitoring type information is of an output type, the metric calculation information includes at least one of the following: information required for calculation of positioning reference units (PRUs), information required for calculation of a NON-RAT positioning mode, positioning reference unit (PRU) information, or NON-RAT information.
17. The method according to any one of Supplements 1 to 16, wherein the method further includes:
the model monitoring apparatus further transmits model abnormality information to the model result output apparatus in a case where no statistical information is able to be obtained.
18. An AI/ML model monitoring method, including:
a model result output apparatus transmits a model monitoring request to a model monitoring apparatus;
wherein the model monitoring apparatus transmits request information for requesting model information to a model deployment apparatus, and receives model information fed back by the model deployment apparatus.
19. The method according to Supplement 18, wherein the method further includes:
the model result output apparatus receives request information for requesting environmental information from the model monitoring apparatus; and
the model result output apparatus feeds back the environmental information to the model monitoring apparatus.
20. The method according to Supplement 19, wherein the environmental information includes at least one of the following: signal measurement information, or environmental statistical information.
21. The method according to Supplement 20, wherein the environmental statistical information includes at least one of the following: positioning reference unit (PRU) information, positioning reference unit (PRU) statistical information, NON-RAT information, NON-RAT positioning statistical information, or LOS/NLOS statistical information.
22. The method according to Supplement 21, wherein
the positioning reference unit (PRU) statistical information includes at least one of the following: information on the number of available PRUs in a current environment, type information of available PRUs in the current environment, measurement content information supported by available PRUs in the current environment, beam information corresponding to available PRUs in the current environment, or measurement sample information able to be provided by available PRUs in the current environment.
23. The method according to Supplement 21, wherein
the NON-RAT positioning statistical information includes at least one of the following: positioning manner information of an available NON-RAT in the current environment, positioning accuracy information of the available NON-RAT in the current environment, or content information required for implementing the NON-RAT.
24. The method according to Supplement 21, wherein
the LOS/NLOS statistical information includes at least one of the following: LOS/NLOS ratio information per cell, or LOS/NLOS information per transmit beam.
25. The method according to any one of Supplements 18 to 24, wherein the method further includes:
the model result output apparatus receives model monitoring decision information fed back by the model monitoring apparatus.
26. The method according to Supplement 25, wherein the model monitoring decision information includes at least one of the following: monitoring type information, metric calculation information corresponding to monitoring modes, model input information, or model output information;
the model input information including at least one of the following: confidence information of model input monitoring, accuracy information of model input monitoring, or metric information of model input monitoring.
27. The method according to Supplement 26, wherein in a case where the monitoring type information is of an input type, the metric calculation information includes at least one of the following: statistical information of real-time reporting model input, collection period information, quality threshold information, a monitoring period, or monitoring metrics.
28. The method according to Supplement 26, wherein in a case where the monitoring type information is of an output type, the metric calculation information includes at least one of the following: information required for calculation of positioning reference units (PRUs), information required for calculation of a NON-RAT positioning mode, positioning reference unit (PRU) information, or NON-RAT information.
29. The method according to any one of Supplements 18 to 28, wherein the method further includes:
the model result output apparatus receives model abnormality information transmitted by the model monitoring apparatus in a case where no statistical information is able to be obtained.
30. An AI/ML model monitoring method, including:
a model deployment apparatus receives request information for requesting model information from the model monitoring apparatus; and
the model deployment apparatus feeds back model information to the model monitoring apparatus.
31. The method according to Supplement 30, wherein the model monitoring apparatus specifies a reporting period and a maximum reporting resource in the request information, and the model deployment apparatus determines the fed-back model information within a range of the maximum reporting resource according to the reporting period.
32. The method according to Supplement 30, wherein the model monitoring apparatus specifies a reporting mode and reporting contents in the request information, and the model deployment apparatus feeds back the model information according to the reporting mode and the reporting contents.
33. The method according to Supplement 30, wherein the model monitoring apparatus transmits the request information periodically, or the model monitoring apparatus transmits the request information aperiodically.
34. The method according to any one of Supplements 30 to 33, wherein the model information includes at least one of the following: data statistical information, latency distribution information, or reception beam information.
35. The method according to Supplement 34, wherein the data statistical information includes at least one of the following: statistical average data of a CIR, peak data of a CIR, statistical average data of RSRP, peak data of RSRP, statistical average data of RSRPP, peak data of RSRPP, a cell identification to which a device providing input data corresponds, or distribution information of reception beams corresponding to input data.
36. A model monitoring apparatus, including a memory and a processor, the memory storing a computer program, and the processor being configured to execute the computer program to implement the AI/ML model monitoring method according to any one of Supplements 1 to 17.
37. A model result output apparatus, including a memory and a processor, the memory storing a computer program, and the processor being configured to execute the computer program to implement the AI/ML model monitoring method according to any one of Supplements 18 to 29.
38. A model deployment apparatus, including a memory and a processor, the memory storing a computer program, and the processor being configured to execute the computer program to implement the AI/ML model monitoring method according to any one of Supplements 30 to 35.
39. A communication system, including:
the model monitoring apparatus according to Supplement 36;
the model result output apparatus according to Supplement 37; and
the model deployment apparatus according to Supplement 38.

What is claimed is:

1. A model monitoring apparatus, comprising:
a receiver configured to receive a model monitoring request transmitted by a model result output apparatus; and
a transmitter configured to transmit request information for requesting model information to a model deployment apparatus,
wherein the receiver is further configured to receive model information fed back by the model deployment apparatus.

2. The apparatus according to claim 1, wherein the transmitter is further configured to specify a reporting period and a maximum reporting resource in the request information, and the model deployment apparatus determines the model information to be fed back within a range of the maximum reporting resource according to the reporting period.

3. The apparatus according to claim 1, wherein the transmitter is further configured to specify a reporting mode and reporting contents in the request information, and the model deployment apparatus feeds back the model information according to the reporting mode and the reporting contents.

4. The apparatus according to claim 1, wherein the transmitter is further configured to periodically transmit the request information, or the transmitter is further configured to aperiodically transmit the request information.

5. The apparatus according to claim 1, wherein the model information comprises at least one of the following: data statistical information, latency distribution information, or reception beam information.

6. The apparatus according to claim 5, wherein the data statistical information comprises at least one of the following: statistical average data of a channel impulse response, peak data of a channel impulse response, statistical average data of reference signal received power, peak data of reference signal received power, statistical average data of reference signal received path power, peak data of reference signal received path power, a cell identification to which a device providing input data corresponds, or distribution information of reception beams corresponding to input data.

7. The apparatus according to claim 1, wherein the transmitter is further configured to transmit request information for requesting environmental information to the model result output apparatus,
and the receiver is further configured to receive environmental information fed back by the model result output apparatus.

8. The apparatus according to claim 7, wherein the environmental information comprises at least one of the following: signal measurement information, or environmental statistical information.

9. The apparatus according to claim 8, wherein the environmental statistical information comprises at least one of the following: positioning reference unit information, positioning reference unit statistical information, non-radio access technology information, non-radio access technology positioning statistical information, or line of sight/non-line of sight statistical information.

10. The apparatus according to claim 9, wherein,
the positioning reference unit statistical information comprises at least one of the following: information on the number of available positioning reference units in the current environment, type information of available positioning reference units in the current environment, measurement content information supported by available positioning reference units in the current environment, beam information corresponding to available positioning reference units in the current environment, or measurement sample information able to be provided by available positioning reference units in the current environment;
the non-radio access technology positioning statistical information comprises at least one of the following: positioning manner information of an available non-radio access technology in the current environment, positioning accuracy information of the available non-radio access technology in the current environment, or content information required for implementing the non-radio access technology; and
the line of sight/non-line of sight statistical information comprises at least one of the following: line of sight/non-line of sight ratio information for a cell, or line of sight/non-line of sight ratio information for a transmit beam.

11. The apparatus according to claim 1, wherein the transmitter is further configured to feedback model monitoring decision information to the model result output apparatus.

12. The apparatus according to claim 11, wherein the model monitoring decision information comprises at least one of the following: monitoring type information, metric calculation information corresponding to monitoring modes, model input information, or model output information;
the model input information comprising at least one of the following: confidence information of model input monitoring, accuracy information of model input monitoring, or metric information of model input monitoring.

13. The apparatus according to claim 12, wherein in a case where the monitoring type information is of an input type, the metric calculation information comprises at least one of the following: statistical information of real-time reporting model input, collection period information, quality threshold information, a monitoring period, or monitoring metrics.

14. The apparatus according to claim 12, wherein in a case where the monitoring type information is of an output type, the metric calculation information comprises at least one of the following: information required for calculation of positioning reference units, information required for calculation of a non-radio access technology positioning mode, positioning reference unit information, or non-radio access technology information.

15. The apparatus according to claim 1, wherein,
the transmitter is further configured to transmit model abnormality information to the model result output apparatus in a case where no statistical information is able to be obtained.

16. A model result output apparatus, comprising:
a model monitoring apparatus, and
a transmitter configured to transmit a model monitoring request to the model monitoring apparatus,
wherein the model monitoring apparatus transmits request information for requesting model information to a model deployment apparatus, and receives model information fed back by the model deployment apparatus.

17. The apparatus according to claim 16, wherein the apparatus further comprises:
a receiver configured to receive request information for requesting environmental information from the model monitoring apparatus; and
the transmitter is further configured to feed back the environmental information to the model monitoring apparatus.

18. The apparatus according to claim 17, wherein the receiver is further configured to receive model monitoring decision information fed back by the model monitoring apparatus.

19. The apparatus according to claim 17, wherein the receiver is further configured to receive model abnormality information transmitted by the model monitoring apparatus in a case where no statistical information is able to be obtained.

20. A model deployment apparatus, comprising:
a receiver configured to receive request information for requesting model information from a model monitoring apparatus; and
a transmitter configured to feed back model information to the model monitoring apparatus.
